(19) United States
(12) Patent Application Publication
(10) Pub. No.: US 2006/0218160 A1
(43) Pub. Date: Sep. 28, 2006

(54) Change control management of XML documents

(75) Inventor: Rishi Bhatia, Walpole, MA (US)

Correspondence Address: BAKER BOTTS L.L.P., 2001 ROSS AVENUE, SUITE 600, DALLAS, TX, 75201-2980, US

(73) Assignee: Computer Associates Think, Inc.

(21) Appl. No.: 11/088,700

(22) Filed: Mar. 24, 2005

(51) Int. Cl. G06F 7/00

(52) U.S. Cl. 707/100

(57) ABSTRACT

A method and system for change control management of XML documents are provided. The XML change control management method incorporates a novel process of examining and comparing XML documents node-by-node instead of the conventional line-by-line methods. The node-by-node method allows for comparison of matching XML nodes that may be in different relative positions within the two files compared. The method includes the steps of determining a structure for a first data file; determining a structure for a second data file; and comparing the first and second structures and outputting the structural differences.

### BACKGROUND

1. Field

The present disclosure relates generally to data processing and computing systems, and more particularly, to a method and system for comparing at least two versions of a data file and for outputting a file indicating differences in the at least two versions.

2. Description of the Related Art

XML (Extensible Markup Language) is a markup language for documents containing structured information. Structured information contains both content, e.g., words, pictures, etc., and some indication of what role that content plays, for example, content in a section heading has a different meaning from content in a footnote, which has a different significance than content in a figure caption or content in a database table, etc. Almost all documents have some structure. A markup language is a mechanism to identify structures in a document. The XML specification defines a standard way to add markup to documents.

XML is fast becoming the key language for information exchange over the web. XML/XSD is self-describing and platform independent. Most of the Fortune™ 500 companies are already using XML for automatic processing of their invoices, billing, accounts, inventory, automatic replenishment and data movement. As applications are increasingly designed to depend upon XML, it is becoming essential to accurately identify and control changes to the data contained within an XML file.

Currently, change management software treats XML as a normal text file; however, XML is structured and traditional line based comparison doesn't yield any meaningful information.

Therefore, a need exists for techniques for change control management of XML and its schemas.

### SUMMARY

A method and system for comparing at least two versions of a structured data file, e.g., an XML file, and for outputting a file indicating differences, e.g., a diff file, in the at least two versions are provided. The method of the present disclosure is described in generic terms for all LCM (Life Cycle Management) products. In general, XML files are provided as reference for discussion in this disclosure, the same set of processes will be available for Schema (XSD) files. The methods of the present disclosure will maintain XML versions; compare different XML versions; merge XML files; and provide for a smarter comparison of original XML files with their modified versions.

The methods and systems of the present disclosure will incorporate the following features: an innovative method of XML document comparison; computation of the structure of the XML files; a user interface that will allow the user to view the actual structural differences or actual line based differences; Type and Namespace based comparison of the structural nodes; an optimized structural analysis and comparison process for structurally different groups of data; ability to create fast run time diff files from a command line; ability to create new XML versions from a diff file; a new merge process making use of the new structural comparison tool to create new structure and data; a process for changing structure or namespace information for all sets of data in an XML file; and unordered comparison of XML files.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a first XML file including initial data;

FIG. 2 is a second XML file to be compared to the XML file of FIG. 1;

FIGS. 3A and 3B are screenshots of an output of a structure of the XML files of FIGS. 1 and 2 respectively;

FIGS. 4A-F is a flowchart illustrating a method for comparing data files in accordance with an embodiment of the present disclosure;

FIG. 5 is a chart of a memory tree output for the first XML file of FIG. 1;

FIG. 6 is a chart of a memory tree output for the second XML file of FIG. 2;

FIG. 7 is a chart of a differential output tree;

FIG. 8 is an exemplary computer system for implementing various embodiments of the methods of the present disclosure;

FIG. 9-11 are exemplary graphical representations of XML files in accordance with the present disclosure; and

FIG. 12 is a flowchart illustrating a method for updating an XML file in accordance with the present disclosure.

### DETAILED DESCRIPTION

Preferred embodiments of the present disclosure will be described herein below with reference to the accompanying drawings. In the following description, well-known functions or constructions are not described in detail to avoid obscuring the present disclosure in unnecessary detail.

Definitions are provided below for the terms used herein.

Glossary of Terms

1. XML Elements can contain other elements, data and attributes and have a start and an end tag.

### EXAMPLE 1

<?xml version=“1.0” encoding=“UTF-8” standalone=“yes”?>

<Billionaires State=“Omaha”>

<!-List of Billionaires by State-->
<Name>

<FirstName> Warren </FirstName>
<LastName> Buffet </LastName>

</Name>

</Billionaires>

In the above example 1, the XML nodes Billionaires, Name, FirstName and LastName are elements. XML elements have relationships with other elements, these relationships create a hierarchical or tree-like structure.

2. Attributes are used to provide additional information about elements. In example 1 above, State is an attribute with Value “Omaha”. Attributes cannot have children and they always belong to an element.

3. Namespaces: XML Namespaces help distinguish between different elements and attributes by associating them with certain vocabularies identified as namespaces. An element in one namespace may have the same name but different attributes as an unrelated element in another namespace. By specifying one or more namespaces within an XML file, the two unrelated elements with the same name can coexist.

4. CData flags or sections are used to block text or markup, which is otherwise prohibited in an XML file, thus providing a means for commenting XML markup. An XML Parser will ignore text inside a CData Section.

5. Repeating flag is a special flag attributed to an element that repeats multiple times.

### EXAMPLE 2

<?xml version=“1.0” encoding=“UTF-8”

standalone=“yes” ?>
<Billionaires State=“Omaha”>

<!-List of Billionaires by State-->
<Person>

<Name >

<FirstName> Warren </FirstName>
<LastName> Buffet </LastName>

</Name>
<Contact Information>

<Address>

...

</Address>
<Phone> 308-308-0999 </Phone>
<Phone> 308-308-0929 </Phone>
<Phone> 308-308-0939 </Phone>
<Phone> 308-308-0949 </Phone>

</Contact Information>

</Person>

</Billionaires>

In example 2, the element Phone is a repeating element. In the structural definition, as will be described below, instead of defining this node four times, Phone will be marked as repeating element.

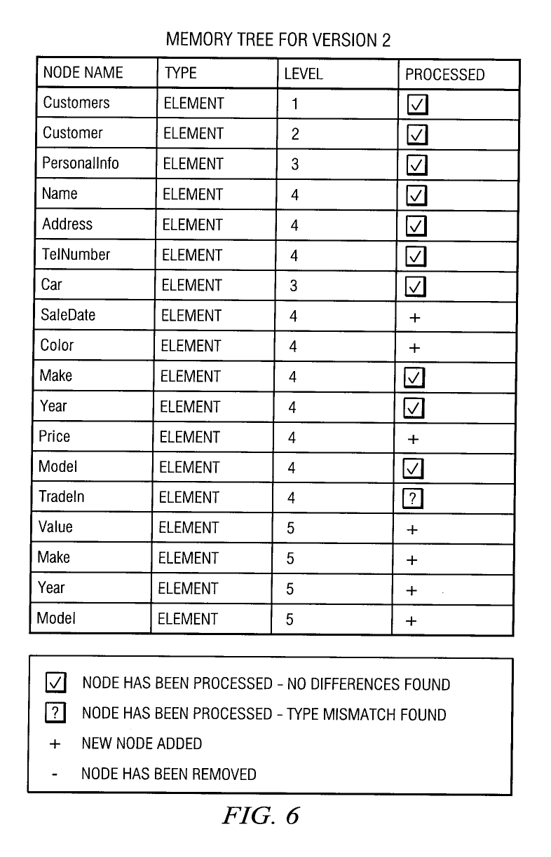

6. Repeating Record, by definition, is a record that repeats. Referring to FIG. 10, PurchaseOrder2.xml is an XML target file for all the orders processed by a company, where Comments is a repeating element while Product and Supplier are repeating records. Every Order element has a repeating element called Comments that contains customer comments about the delivery and their interaction with company. An Order element can contain multiple Product records. Since multiple suppliers can ship each product, the Product record may have multiple Supplier records. Repeating records can be nested; for example, an instance of the Product record can have many instances of the Supplier record.

Conventionally, all source control management systems compare XML files as text, the result being a line based comparison. However, since XML is structured, the line based comparison does not yield very meaningful information. The XML comparison method of the present disclosure is more structured. As the usage and size of XML grows, smarter comparison will be highly desired. The techniques of the present disclosure implement the following high level steps required to provide smarter comparison:
The structure of the both the XML files, e.g., an initial version and modified version, will be generated for smarter comparison.
List version methods for XML and schema file format will be extended to invoke the new functionality for XML file format.
The smarter comparison process will compare the structures of the two XML files.
The output will be the metadata or structural difference between the two files, e.g., a diff file.
A user interface will allow the user to view the actual structural differences or actual line based difference.

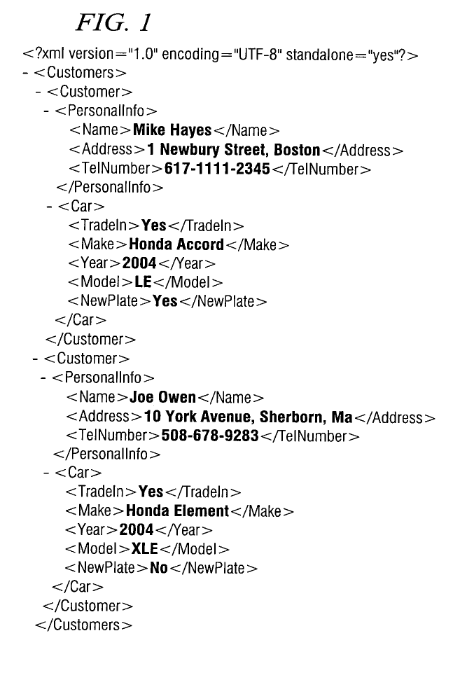

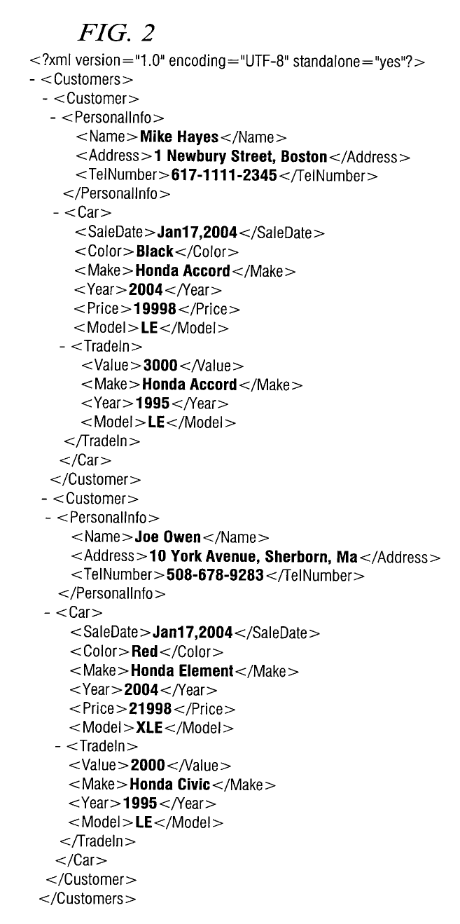

An illustrative example will now be provided to explain the method of the present disclosure employing a very simple customer XML file from a car dealership. In the real world, the actual data XML file will be a lot more complex, but a simple XML file has been chosen for clarity and to better to explain the process. FIG. 1 illustrates the initial XML syntax containing the custom information, e.g., XML1.xml, and FIG. 2 illustrates the more refined version of XML used for capturing the customer information at the central level, e.g., XML2.xml.

Conventional comparison tools compare the two XML files line-by-line and generate a line-based differences file. Even with just a simple XML use case, the differences can be hard to determine in a simple line based comparison tool. This disclosure describes a better way of performing the comparison. First, the structure of the source XML is determined (e.g., the initial XML file). Then, the structure of the new or changed XML (e.g., the modified XML file) is generated. The new comparison procedure will compare the two structures and generate a differential file, e.g., a diff file, based upon it.

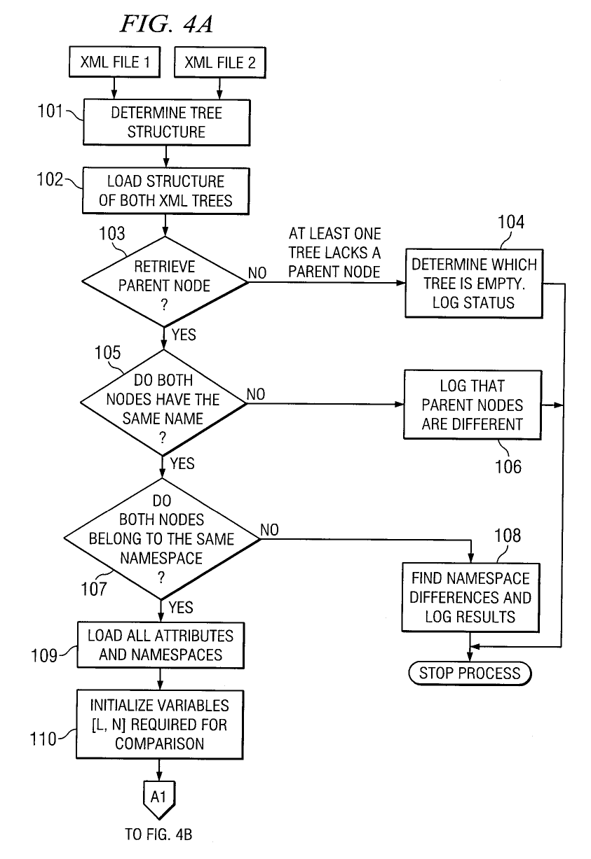

Referring to FIG. 4A-F, a detailed flowchart of the comparison process is illustrated. Initially, a structure for each XML document tree is identified along with their node types, levels and namespace in step 101. A method for determining the structure of an XML file is described in co-pending U.S. patent application Ser. No. ______, entitled, “METHOD AND SYSTEM FOR EXTRACTING STRUCTURAL INFORMATION FROM A DATA FILE”, [Attorney Docket No. 20000415], the contents of which are herein incorporated by reference.

Using the customer XML files from the example described above, e.g., XML1 and XML2, the structure of the source or version 1 of XML is:

<Customers>

<Customer>

<PersonalInfo>

<Name>
<Address>
<TelNumber>

<Car>

<TradeIn>
<Make>
<Year>
<Model>
<NewPlate>

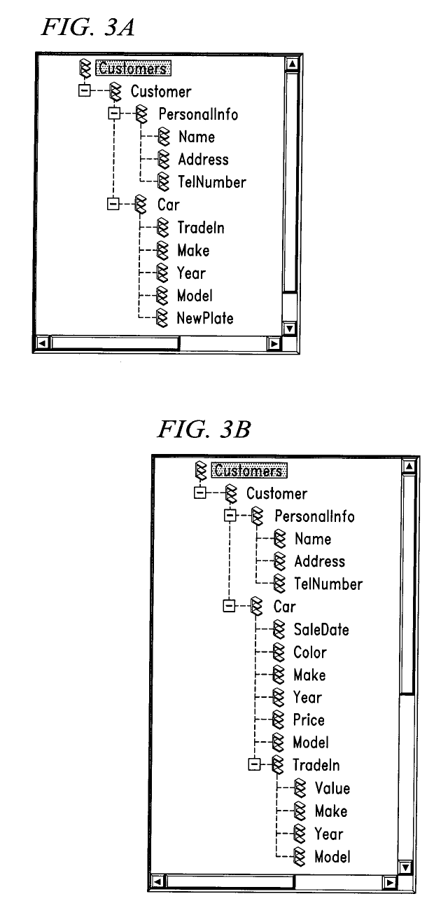

The procedure will also determine the type of each node or component. The permissible values of the nodes are: Element, Attribute, Namespace and Comment. The structure of the XML tree for the Customer XML version 1 of FIG. 1 is shown in Table 1, below and an exemplary output screenshot of the structure is illustrated in FIG. 3A.

TABLE 1
Customer XML Version 1

| Node Name | Node Type | Level |
|---|---|---|
| Customers | Element | 1 |
| Customer | Element | 2 |
| PersonalInfo | Element | 3 |
| Name | Element | 4 |
| Address | Element | 4 |
| TelNumber | Element | 4 |
| Car | Element | 3 |
| TradeIn | Element | 4 |
| Make | Element | 4 |
| Year | Element | 4 |
| Model | Element | 4 |
| NewPlate | Element | 4 |

The same is done for the second XML file, e.g., Customer XML Version 2 of FIG. 2, where FIG. 3B is a output screenshot thereof:

TABLE 2
Customer XML Version 2

| Node Name | Node Type | Level |
|---|---|---|
| Customers | Element | 1 |
| Customer | Element | 2 |
| PersonalInfo | Element | 3 |
| Name | Element | 4 |
| Address | Element | 4 |
| TelNumber | Element | 4 |
| Car | Element | 3 |
| SaleDate | Element | 4 |
| Color | Element | 4 |
| Make | Element | 4 |
| Year | Element | 4 |
| Price | Element | 4 |
| Model | Element | 4 |
| TradeIn | Element | 4 |
| Value | Element | 5 |
| Make | Element | 5 |
| Year | Element | 5 |
| Model | Element | 5 |

Next, the structures for each of the trees are loaded in memory (step 102). Proceeding to step 103, the top level, or parent, node is identified for each tree and retrieved. If at least one tree is missing a valid parent node, then proceeding to step 104, the trees are individually inspected to determine which of the trees is empty, the lack of nodes for comparison is noted in a log and the process is terminated. However, if both trees contain valid parent nodes, the method provides a check of the parent node to determine if the parent node names match for both trees in step 105. If the node names do not match, the occurrence of a parent node mismatch is logged and the process is terminated, in step 106.

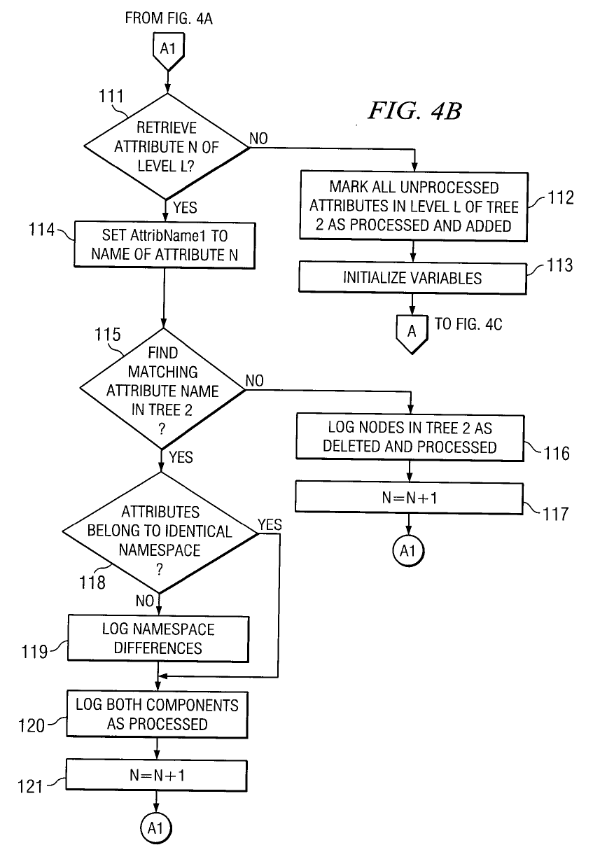

It should be noted that the term ‘log’ as employed in the description of the present disclosure should be construed to include, but is not limited to, a set of memory blocks, specific file, printed output, or dialog box displayed on a display screen configured to provide a feedback to an operator of the status and/or outcome of the various steps of the disclosed process and/or record same for internal status tracking such as the various outputs shown in FIGS. 5, 6 and 7.

Alternatively, if the two parent nodes have matching names, then the associated Namespace of each is determined and compared to determine identicalness, in step 107. In the case of non-identical Namespaces, the method analyzes the parent nodes to determine if one is missing a Namespace or if both nodes simply have different Namespaces in step 108. The outcome of the analysis performed in step 108 is logged and the process is terminated. The parent nodes are deemed identical if either both Namespaces are identical or if both parent nodes do not specify a Namespace.

In the case of identical parent nodes, the method provides for the retrieval of all attributes and Namespaces assigned to the parent node (step 109); more than one Namespace may be associated with the document.

Proceeding onto step 110, the comparison process initializes variables required for structural comparison, where variable L represents the level in the tree and N represents the attribute number at a specific level. The parent node is assigned level 1; thus starting at level 1, the parent nodes of both trees are compared.

If the retrieval attempt in step 111 is successful, the process proceeds onto step 114, where a variable designated for holding an attribute name is set to the name of the current attribute N of the current node of the first tree. The attribute name variable will be referred herein as AttribName1. A search is subsequently performed of all attributes of the parent node of the second tree for an attribute with a name matching AtrribName1 in step 115.

In the case of a failed search in step 115, e.g., no matching attribute is found in the second tree, all nodes in the second tree are logged as deleted and processed in step 116. Proceeding to step 117, the variable N is incremented by 1 and the process loops back to step 111 and continues on from step 111 as described above using the new value of N.

A successful search in step 115, e.g., a matching attribute is found in the second tree, leads to step 118, wherein a determination is made whether the matching attributes from the first and second trees belong to the identical Namespaces. If the Namespaces are not identical, the Namespace difference is logged in step 119. Once the Namespace difference is logged in step 119 or if the Namespaces are determined to be identical in step 118, the attributes are logged as processed for both the first and second trees in step 120. Proceeding to step 121, the variable N is incremented by 1 and the process loops back to step 111 and continues on from step 111 as described above using the new value of N.

The described loops of step 117 to step 111 and step 121 to step 111 are repeated until step 111 produces a negative outcome, e.g., an attempt is made to retrieve attribute number N of the parent node of the first tree. If the retrieval fails, the process iterates through all remaining unprocessed attributes of the parent node of the second tree; each attribute is logged as having been processed and logged as a newly added attribute, in step 112. In step 113, variable L is incremented and a new N value is computed reflecting the number of components in the current level L and the process continues on to step 122.

In step 122, an attempt is made to retrieve the current component (component number N) in the current level (level L) of the first tree. If the process is unable to retrieve the designated attribute, then no unprocessed attributes remain in the current level and the process is advanced to step 123. At step 123, all remaining, unprocessed components contained in the second tree are logged as processed and added, followed by termination of the process.

Alternatively, upon successful retrieval of the current component in step 122, a variable, herein referred to as CompName1, is set with the name of the current component of the first tree, in step 124. Proceeding on to step 125, a search is performed to locate an unprocessed component having a name matching CompName1 in the second tree at level L. If no matching component is found, the process branches to step 133; this Deleted-Record subroutine will be discussed in detail below. If the search in step 125 finds a component in the second tree that matches the value of CompName1, the process continues to step 126.

In step 126, the matching components are checked to determine if at least one component is a record in either the first or second tree. The process branches to step 139 if at least one component is a record; this Record-Check subroutine is discussed in detail below. However, if neither component is a record, then the process proceeds to step 127 where it is determined if the components match. The method described in the above-identified co-pending application (Attorney Docket No. 20000415) will determine the following properties for each element whether an element is a repeating element or repeating record, and if a CDATA section or flag has been used. Therefore, in step 127, the process will compare these associated properties to determine if the components match.

The various associated types (e.g., attribute, element, namespace, comment, etc.) of the components are compared and evaluated. Type differences, if any are encountered, are logged in step 128 and the process then continues to step 129 where the Namespaces are compared. Any Namespace differences that are encountered are logged in step 130 and the process then continues to step 131 where both components are logged as processed. Proceeding to step 132, the variable N is incremented by 1 (e.g., N=N+1) and the process loops back to step 122, using the new value for variable N.

Deleted Record Subroutine

Referring to FIG. 4D, when no matching component is found in step 125, the process branches of to the Deleted Record subroutine, beginning with step 133, a counter variable, B, is initialized with a value of 1. Step 134 determines if the value of variable B is less than or equal to the total number of branches in the current record, e.g., B ≦[total branches in record]. If the result is True, then the method in step 135 logs all the nodes of branch B of the current record as deleted and processed and, in step 136, increments variable B by 1. The process then loops back to step 134 to process the next unprocessed branch in the current record. Alternatively, when the result of step 134 is False, the method in step 137 logs all the nodes of branch B of the current record as deleted and processed, and in step 138 increments variable N by 1.

Record-Check Subroutine

As shown in FIG. 4E, when, in step 126, a determination is made that at least one component is a record in either the first or second tree, the process proceeds to step 139 where a variable R is initialized. Variable R is set to one of the following values, Tree 1, Tree 2 or Both, depending on whether the component in tree 1 or tree 2 is a record or if both components are records. In step 140, the method evaluates variable R, and if R is not set to Both, the process branches to the Single Record subroutine starting at step 149, which will be discussed in detail below.

When R is set to Both, the process continues to step 141. In step 141, the structures of both records, e.g., tree 1 component and tree 2 component, are retrieved and in step 142, the structures, types and Namespaces of the two records are compared. If both records are identical, the process skips directly to step 145; however, any Namespace differences encountered are logged in step 143 and any type differences are logged in step 144. The process then continues on to step 145, where the two components are logged as processed and the variable N is incremented by 1 in step 146. The method then loops back to step 122 to process the next unprocessed component.

Single Record Subroutine

The Single Record subroutine is invoked when variable R is set to either Tree 1 or Tree 2, as shown in FIG. 4F. In step 149, the method determines which tree contains the record component. If tree 1 contains the record component, then the process proceeds to step 150, where all components contained within the record are logged as deleted and processed. In step 151, the component in tree 2 is logged as added (e.g., new component) and processed.

A similar procedure is followed if tree 2 contains the record component. In this case, the method proceeds to step 152 instead of step 150. In step 152, all components contained within the record of tree 2 are logged as added and processed. In step 153, the component in tree 1 is logged as deleted and processed.

In both cases, upon completion of either step 151 or step 153, the process increments variable N by 1 in step 154 and loops back to step 122 to process the next unprocessed component. The process continues in this manner until the entire structure of both document trees has been analyzed.

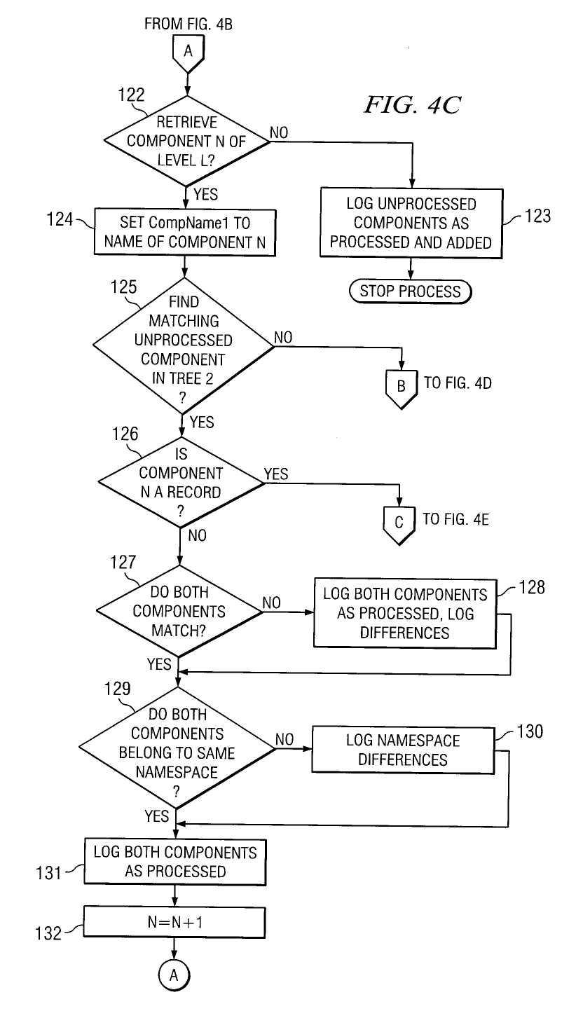

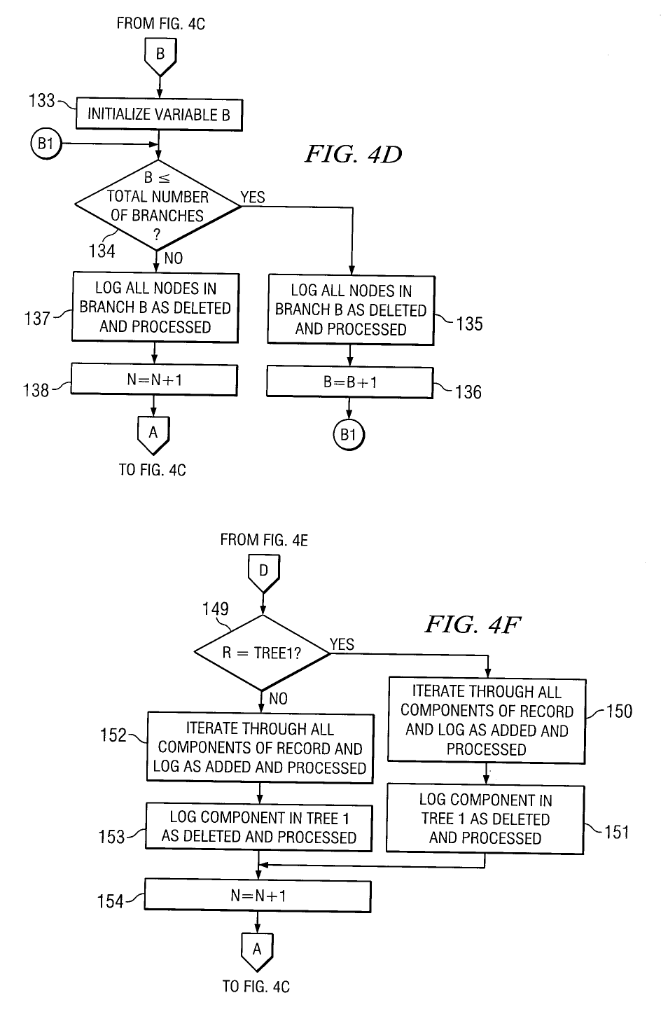

FIG. 5 illustrates the memory tree for version 1 of the XML file, FIG. 6 illustrates the memory tree for version 2 and FIG. 7 illustrates a summary of the differences between the memory trees for version 1 and 2. Referring to FIG. 7, the result or the difference between the two XML trees is:
1. An Element called Newplate has been removed at Level 4 in tree1.
2. Elements SaleDate, Color and Price have been added at Level 4 in tree 2.
3. The type of Element TradeIn has been changed in tree 2; the new TradeIn element is a parent with the following four sub elements Value, Make, Year and Model.

By reading this summary, the user can easily determine the main differences between the two versions. The benefits of the method of the present disclosure are numerous: node order doesn't make a difference; the comparison is very meaningful and it practically takes users no time to spot and comprehend the difference; if two different XML files are being compared, then the search spots the difference right away; ability to take meaningful difference and consume it in other processes, or to propagate, publish the change via email or portal; easier to review differences if the XML changes are to be accepted or rejected; and requires no extra effort on part of the user to generate the smarter comparison. Along with the summary of the comparison, the user may be provided an option to view the differences for each point and also to look at the actual line based differences.

In an alternative embodiment, the method can generate fully qualified component names. This method can lead to a different implementation of the structural comparison process where the actual fully qualified structure nodes can be compared. The benefit is that the search for the specific nodes will be much faster and this can fasten the comparison process as well. Since the nodes generated from the process will be fully qualified, the information about the levels of each node is not required and the comparison process can even compare the nodes in the linear fashion.

Creating New XML File from Diff File

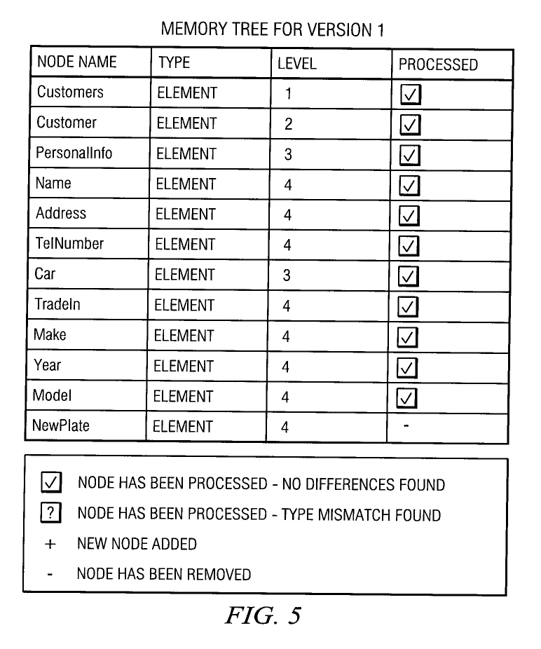

The steps involved in creating a new XML file from one or more diff files will be explained by way of example with reference to FIGS. 9-11. PurchaseOrder is an XML target file for all the orders processed by a company. FIG. 9 shows the structure for a first version of the PurchaseOrder.xml.

A revised version of PurchaseOrder was created as shown in FIG. 10. Now, every Order has a repeating element called “Comments” (denoted by the letter “R”) that contains customer comments about the delivery and their interaction with the company. One Order can contain multiple products and multiple suppliers can ship each Product.

By using the algorithm described above, the difference between the XML files is shown in the diff file of Table 3 below.

TABLE 3

| Tree | Node Name | Type | Level | Result |
|---|---|---|---|---|
| Tree 1 | Comment | Element (Repeating) | 3 | + |
| Tree 1 | Supplier | Element (Repeating Record) | 4 | + |

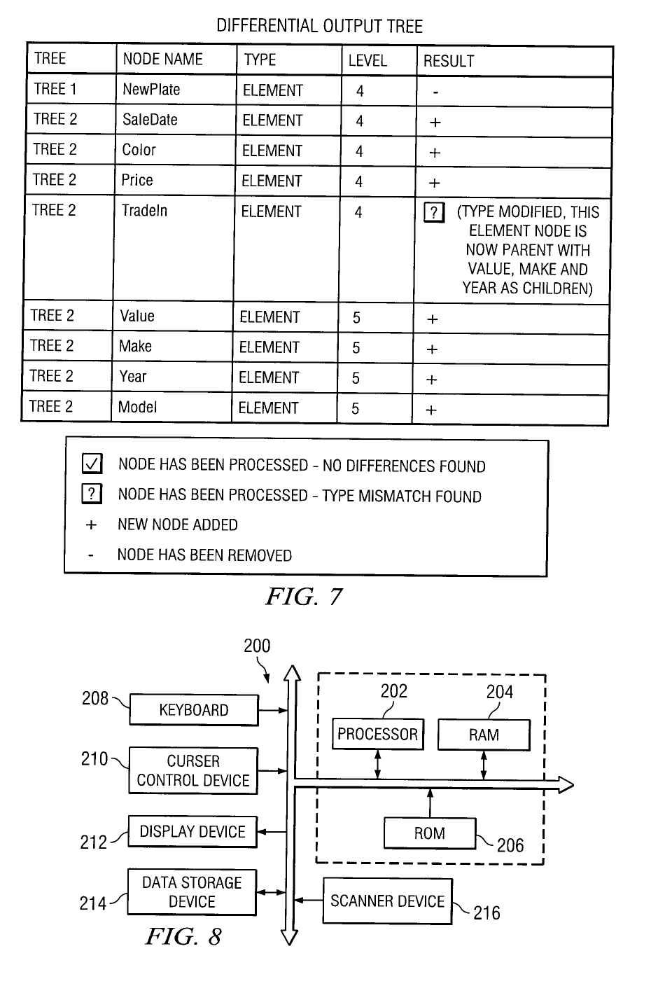

The resulting diff file identifies a new element called Comment at level 3 and a new repeating record called Supplier at Level 4. Let's call difference 1 (i.e., Comment) as Diff1 and difference 2 (i.e., Supplier) as Diff2. Diff1 and Diff2 may now be used to create new versions of the XML file. A user can specify which version of the XML files are to be used and which diffs are to be applied. So the user can create a new version of the XML file (see FIG. 11, PurchaseOrder3.xml) by applying Diff2 to the base version of the file. The resulting PurchaseOrder3.xml contains the base XML file (FIG. 9) and the Diff2 change for the comment. At run time, the user can create new versions of an XML file by choosing which tags or diffs to apply to the specified XML versions, thus, PurchaseOrder Base XML+Diff 1 can be used to create the PurchaseOrder3 version, as will be described below.

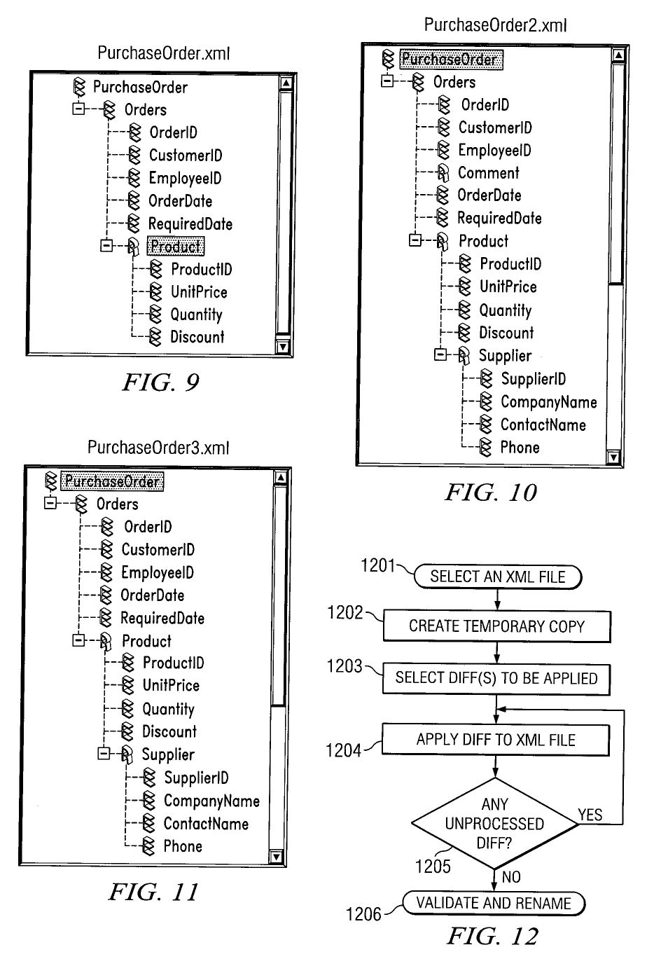

Referring to FIG. 12, the process begins with the user specifying a base XML file in step 1201. The user-specified XML file is used to create a temporary copy of the XML file in step 1202. Step 1203 provides the user with a set of Diffs to select from. Once one or more Diffs are selected, the first selected Diff is applied to the base XML file in step 1204.

If the Diff specifies the addition of a new node, then the Data specified by the Diff is copied into the temporary copy of the XML file. If the new node is a record then the whole record is also copied. If an element is a repeating record then all the instances of this repeating record are copied.

If the Diff specifies the deletion of a node, then the Data specified by the Diff is deleted from the temporary copy of the XML file. If the node is a record, then the whole record is deleted. If the node is a repeating record, then all instances of this repeating record are deleted.

In step 1205, the process determines if any selected Diffs remain unprocessed. If additional selected Diffs remain, then the process returns to step 1204, this time using the next selected Diff. This loop continues until no unprocessed selected Diffs remain, at which point the process continues to step 1206. In step 1206, the new structure of the XML file is validated and the temporary file is renamed to a user-specified XML file name, thus replacing the original XML file. FIG. 11 shows the structure of an XML file resulting from the application of Diff2 of Table 3 to PurchaseOrder.xml (FIG. 9).

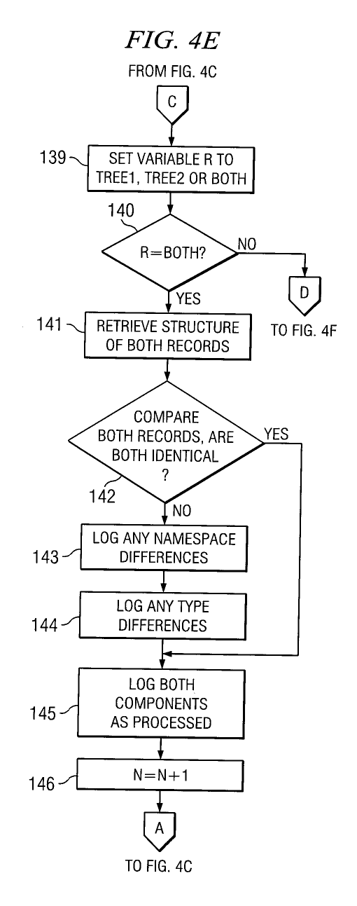

It is to be understood that the present disclsoure may be implemented in various forms of hardware, software, firmware, special purpose processors, or a combination thereof. In one embodiment, the present disclosure may be implemented in software as an application program tangibly embodied on a program storage device. The application program may be uploaded to, and executed by, a machine 200 comprising any suitable architecture such as personal computers or servers. Referring to FIG. 8, preferably, the machine 200 is implemented on a computer platform having hardware such as one or more central processing units (CPU) 202, a random access memory (RAM) 204, a read only memory (ROM) 206 and input/output (I/O) interface(s) such as a keyboard 208, cursor control device 210 (e.g., a mouse or joystick) and display device 212. The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device, a printing device and a scanning device 216.

It is to be further understood that, because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure.

The described embodiments of the present disclosure are intended to be illustrative rather than restrictive, and are not intended to represent every embodiment of the present disclosure. Various modifications and variations can be made without departing from the spirit or scope of the disclosure as set forth in the following claims both literally and in equivalents recognized in law.

What is claimed is:

1. A method for comparing at least two structured data files, the method comprising the steps of:
determining a structure for a first data file;
determining a structure for a second data file; and
comparing the first and second structures and outputting the structural differences.

2. The method of claim 1, wherein the determining a structure step includes:
determining a plurality of nodes in the first and second data files; and
determining a node type for each of the plurality of nodes.

3. The method of claim 2, wherein the determining a structure step includes determining a level for each of the plurality of nodes.

4. The method of claim 3, wherein the nodes types are chosen from the group consisting of element, attribute, namespace and comment.

5. The method of claim 4, wherein the comparing step further comprises:
comparing a parent node of the first data file to a parent node of the second data file;
determining if the parent node of the first data file matches the parent node of the second data file; and
if the parent nodes do not match, determining the first and second data files are different.

6. The method of claim 5, wherein the comparing step further comprises:
retrieving at least one node of the first data file and determining the level for the at least one node;
searching in the second data file at the determined level for the at least one node; and
determining if the at least one node of the first data file matches the at least one node of the second data file.

7. The method of claim 6, wherein the determining if the at least one node of the first data matches the at least one node of the second data file step includes the step of determining if the nodes are of an identical type.

8. The method of claim 6, wherein the determining if the at least one node of the first data file matches the at least one node of the second data file step includes the step of determining if the nodes belong to the same namespace.

9. The method of claim 6, wherein if the at least one node of the first data file matches the at least one node of the second data file, further comprising the steps of:
determining at least one attribute of the at least one node of the first data file; and
determining if the at least one attribute exists in the at least one node of the second data file.

10. The method as in claim 6, further comprising the step of searching for other nodes at the determined level in the second data file and marking found nodes as additions.

11. The method as in claim 6, wherein if the at least one node of the first data file does not matches the at least one node of the second data file, marking the at least one node of the first data file as deleted.

12. The method of claim 1, wherein the outputting the structural differences step comprises generating a list of additions and deletions and associating each addition and deletion to the first or second data file.

13. The method of claim 12, further comprising the steps of:
selecting at least one addition or deletion; and
applying the selected at least one addition or deletion to the first or second data file to create a third data file.

14. A program storage device readable by a machine, tangibly embodying a program of instructions executable by the machine to perform method steps for comparing at least two structured data files, the method steps comprising:
determining a structure for a first data file;
determining a structure for a second data file; and
comparing the first and second structures and outputting the structural differences.

15. The program storage device of claim 14, wherein the determining a structure step includes:
determining a plurality of nodes in the first and second data files; and
determining a node type for each of the plurality of nodes.

16. The program storage device of claim 15, wherein the determining a structure step includes determining a level for each of the plurality of nodes.

17. The program storage device of claim 16, wherein the nodes types are chosen from the group consisting of element, attribute, namespace and comment.

18. The program storage device of claim 17, wherein the comparing step further comprises:
comparing a parent node of the first data file to a parent node of the second data file;
determining if the parent node of the first data file matches the parent node of the second data file; and
if the parent nodes do not match, determining the first and second data files are different.

19. The program storage device of claim 18, wherein the comparing step further comprises:
retrieving at least one node of the first data file and determining the level for the at least one node;
searching in the second data file at the determined level for the at least one node; and
determining if the at least one node of the first data file matches the at least one node of the second data file.

20. The program storage device of claim 19, wherein the determining if the at least one node of the first data matches the at least one node of the second data file step includes the step of determining if the nodes are of an identical type.

21. The program storage device of claim 19, wherein the determining if the at least one node of the first data file matches the at least one node of the second data file step includes the step of determining if the nodes belong to the same namespace.

22. The program storage device of claim 19, wherein if the at least one node of the first data file matches the at least one node of the second data file, further comprising the steps of:
determining at least one attribute of the at least one node of the first data file; and
determining if the at least one attribute exists in the at least one node of the second data file.

23. The program storage device as in claim 19, further comprising the step of searching for other nodes at the determined level in the second data file and marking found nodes as additions.

24. The program storage device as in claim 19, wherein if the at least one node of the first data file does not matches the at least one node of the second data file, marking the at least one node of the first data file as deleted.

25. The program storage device of claim 14, wherein the outputting the structural differences step comprises generating a list of additions and deletions and associating each addition and deletion to the first or second data file.

26. The program storage device of claim 25, further comprising the steps of:
selecting at least one addition or deletion; and
applying the selected at least one addition or deletion to the first or second data file to create a third data file.

27. A system for comparing at least two structured data files comprising:
means for determining a structure for a first data file;
means for determining a structure for a second data file; and
means for comparing the first and second structures and outputting the structural differences.
